(19) United States
(12) Patent Application Publication
(10) Pub. No.: US 2019/0254899 A1
(43) Pub. Date: Aug. 22, 2019

(54) RETINAL DETACHMENT EYE PILLOW AND CONVERSION METHOD BETWEEN DIFFERENT SERVICE STATES OF HEADREST THEREOF

(71) Applicant: Jianquan CHEN, Woodbridge, CT (US)

(72) Inventor: Jianquan CHEN, Woodbridge, CT (US)

(21) Appl. No.: 16/346,346

(22) PCT Filed: Oct. 30, 2017
(86) PCT No.: PCT/CN2017/108444

§ 371 Date: Apr. 30, 2019

(30) Foreign Application Priority Data
Oct. 31, 2016 (CN) 201610927104.6

(51) Int. Cl. A61G 7/07; A47C 20/02

(52) U.S. Cl. CPC A61G 7/07; A61G 5/121; A47C 20/026

(57) ABSTRACT

Provided is a retinal detachment eye pillow comprising a headrest and a sit-sleeping support for use when sitting in a chair, wherein the headrest receives a user's head; the headrest can be directly placed on the upright sleeping support for use or can also be taken from the upright sleeping support for a patient to use on a bed for prone sleeping; the method for converting use of the headrest: from the upright sleeping support to the bed for prone sleeping is moving the headrest up and detaching it from the upright sleeping support, and putting the headrest on the bed or a bedside tool, such that the patient can sleep on the bed in a prone posture using the headrest; the method for converting use of the headrest from the bed for prone sleeping to the upright sleeping support is picking up the headrest: from the bed or the bedside tool to align it with and putting it down on the upright sleeper support, such that the patient can use the headrest on the upright sleeping support. The eye pillow enables the user to have a very good user experience without having to disassemble or assemble the parts during the conversion. At the same time, the upright sleeping support is designed to be a platform for the headrest, thus it is possible to support headrests produced by other manufacturers.

### FIELD OF THE INVENTION

This invention relates to an eye pillow to help the retinal detachment patient to recover from the eye operation. Normally the retinal detachment patient need to rest or sleep face-down on the bed or sitting on the chair after eye operation, that is to say the patient need to change between 2 face-down positioning, and so the headrest need to change between 2 states.

### BACKGROUND OF THE INVENTION

We had invented a retinal detachment eye pillow with 3 legs, the patient mainly used it for sit-sleeping, but its headrest (FIG. 9) is fixed on the support and very hard to be uninstalled, thus it is mainly used for sit-sleeping, very limited. Lots of the buyers want to disassemble it from the support and add some other parts then put it on the bed and sleep in the prone posture, but as the number of disassembling and assembling increase, the patient will feel that it is very inconvenient to use the eye pillow, and too much of these operations will damage some parts.

In addition, the eye pillow is different from siesta pillow because lots of retinal detachment patients are required to rest or sleep several month in the face-down posture, and lots of hours a day, even 24 hours a day to keep this posture, in addition to that lots of patients are required to keep head or eye horizontally; the siesta pillow is only required for only half an hour, the duration is too short and head posture is not required, most of head posture in the siesta pillow is slanting, if the doctor asked the patient to keep his head horizontally then the slanting head posture in the siesta pillow is absolutely not allowed; thus most of the siesta pillow or regular pillow cannot be used for retinal detachment patient. The regular pillow is a rectangular pillow and cannot be used for retinal detachment patient and it will hurt the said patient because the patient cannot breath easily and even suffocate the patient if the head of the patient is buried face-down in the regular pillow; in addition to this, the patient will feel too hot to survive because the hot air exhaled from nose will accumulate around the nose. Some patients put their head directly in the U-shaped pillow to save money, the U-shaped pillow is directly on the bed but feel very very uncomfortable after several hours because their heads feel too hot since the hot air exhaled from the nose accumulate because of the poor heat dissipation in the U-shaped pillow. In summary the retinal detachment patient is very strict on comfort and is required to keep a special posture, regular pillows and most of the siesta pillows cannot meet these requirements. The technician in this field of retinal detachment eye pillow will not refer to the simple siesta pillow or regular pillow because they will hurt the retinal detachment patients who are required to keep their head horizontally.

### SUMMARY OF THE INVENTION

In order to overcome the disadvantage that the headrest of the eye pillow described above cannot be easily removed for sleeping on the bed in the prone posture, the present invention, a retinal detachment eye pillow and a method for converting between different use states of the headrest thereof, adopts the following technical solutions:

it comprises a headrest and a sit-sleeping support when sitting in a chair (sit-sleeping support or support for short); there is a hole in the said headrest as a respiratory passage when the head is placed in the said headrest, the depth of the said hole is at least as high as the node; the said headrest can be directly placed on the sit-sleeping support for use or be removed for the patient to sleep in the prone posture on the bed; the conversion method from on the sit-sleeping support to sleeping in the prone posture on the bed is: moving the headrest upward, detaching it from the sit-sleeping support, placing it on the bed or a bedside tool, then the patient can sleep in the prone posture on the bed to use the headrest; the conversion method from sleeping in the prone posture on the bed to on the sit-sleeping support is: picking up the headrest from the bed or the bedside tool, align it with the sit-sleeping support, moving it down on the sit-sleeping support, then the patient can use the headrest on the sit-sleeping support.

The major part of the top platform of the sit-sleeping support is a board and there is a protrusion on the said platform, the bottom board of the headrest is flat and there is a concavity in the said bottom board; the top platform contacts with the bottom board of the headrest and support the headrest via the contact; the concavity of the bottom board of the headrest is placed around the protrusion of the top platform to prevent the headrest from moving horizontally; when the patient want sleep while sitting, he can place the concavity of the bottom board of the headrest around the protrusion of the top platform of the sit-sleeping support, or detach the headrest from the sit-sleeping support by moving the headrest upwards if he want to uninstall.

There is another protrusion to help fix the headrest on the top platform of the sit-sleeping support, and there is another concavity in the bottom board of the headrest, where the headrest is placed on the top platform of the support, the said concavity is placed around the protrusion of the top platform of the said support.

There are upwards walls around the top platform of the said support, the bottom board of headrest is flat and can be placed in the wall of the said top platform; or the top platform of the said support is flat, and there are walls around the bottom board of the headrest, the walls can be placed around the top platform of the said support; the top platform of the said support contacts with the bottom board of the headrest and support the headrest via the contact.

There is a rotatable lock-arm on the edge or protrusion of the top platform of the said support, the lock-arm is rotated in to lock the headrest onto the top platform of the said support when in use, or the lock-arm is rotated out when not in use.

More steps related to the lock-arm are required than those in the said method, the conversion method from on the sit-sleeping support to sleeping in the prone posture on the bed is: rotate the lock-arm out, moving the headrest upward, detaching it from the sit-sleeping support, placing it on the bed or a bedside tool, then the patient can sleep in the prone posture on the bed to use the headrest; the conversion method from sleeping in the prone posture on the bed to on the sit-sleeping support is: picking up the headrest from the bed or the bedside tool, align it with the sit-sleeping support, moving it down on the sit-sleeping support, and rotate the lock-arm in to lock the headrest then the patient can use the headrest on the sit-sleeping support.

There are holes for breathing both in the bottom board of the headrest and the top platform of the said support, the said holes are aligned when in use, thus the exhaled air can be discharged out of the headrest and the top platform of the said support.

There is a band on the headrest, when the head of the patient is placed on the headrest, the band is placed around the head of the patient, the both ends of the band is attached on the both sides of the headrest.

The present invention enables the retinal detachment patient to use the headrest on the sit-sleeping support and to sleep on the bed in the prone posture without disassembling or assembling any parts, which is very simple to use and has a very good user experience; at the same time it enables the sit-sleeping support a headrest platform that can support headrests from other manufacturers. Wrap the patient's head with a band to prevent the head of the user from leaving the headrest and sleeping like a normal person facing upwards. In addition, due to the ingenious design of the breathing hole, the patient's breathing is smooth and the heat dissipation is also fast, so that the patient can sleep comfortably.

### BRIEF DESCRIPTION OF THE DRAWINGS

FIG. 1 is the drawing of the retinal detachment eye pillow with the user's head in it

FIG. 2 is the exploded view of the headrest and top platform of the retinal detachment eye pillow

FIG. 3 is the exploded view of the headrest and top platform of the retinal detachment eye pillow with some headrest parts hidden

FIG. 4 is the drawing of top platform of the sit-sleeping support with the headrest on it but some headrest parts are hidden

FIG. 5 is the exploded view of the headrest and top platform of the retinal detachment eye pillow with the lock-arm

FIG. 6 is the drawing of the headrest of the eye pillow is locked on the top platform of the sit-sleeping support by the lock-arm with some headrest parts hidden.

FIG. 7 is the exploded view of the headrest and the walled top platform of the retinal detachment eye pillow with the lock-arm

FIG. 8 is the drawing of the another side of the headrest with a band

FIG. 9 is the drawing of the old design which is hard to uninstall

### BRIEF DESCRIPTION OF THE PARTS

1 the head of the user
2 band
3 headrest
4 headrest base
5 the bottom board of the headrest
6 the top platform of the sit-sleeping support
7 the sit-sleeping support
8 the front protrusion of the top platform
9 screw
10 the rear protrusion of the top platform
11 screw
12 the breathing holes on the top platform
13 the rear concavity of the bottom board of the headrest
14 the breathing hole of the bottom board of the headrest
15 the front concavity of the bottom board of the headrest
16 the spacer on the bottom board of the headrest
17 lock-arm
18 the small base of the headrest
19 screw
20 the loop and hook
21 the walled top platform of the sit-sleeping support
22 the base of the old headrest
23 and 26 angle iron
24 a part to fix the angle of the headrest
25 headrest supporting tube
27 screw or nut

### DETAIL DESCRIPTION OF THE INVENTION

The invention is described in details in conjunction with the drawings.

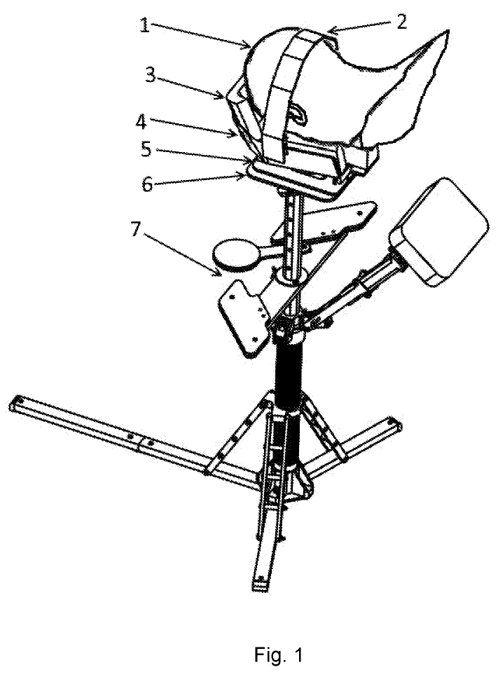

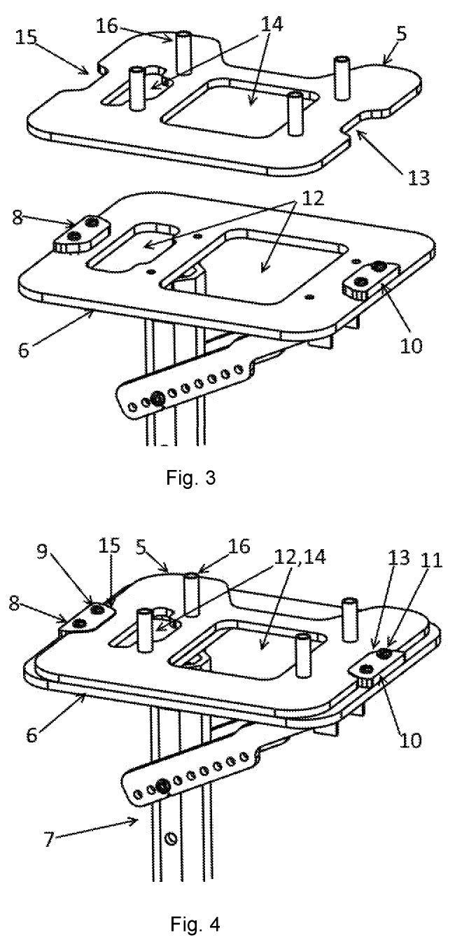

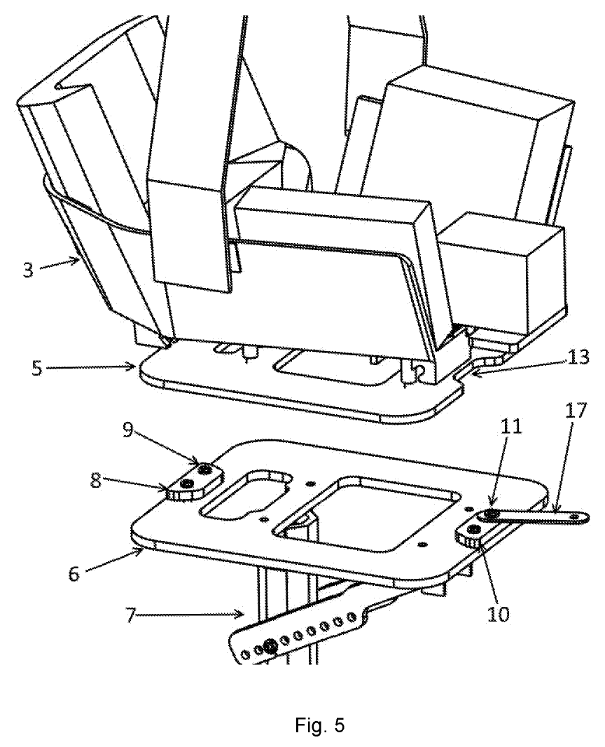

Please refer to FIG. 1-4:
a retinal detachment eye pillow and conversion method between different service states (Embodiment 1) includes:
   a sit-sleeping support 7 and a headrest 3, When the patient is sit-sleeping, the headrest 3 is placed on the sit-sleeping support 7, sitting on the chair against the support 7, and the head is placed in the headrest 3 to sit-sleep. In addition, the sit-sleeping support is placed on the ground, so there are many scenes to be applied, such as hospital wards, bedrooms, living rooms, balconies or outside the house.

There is a top platform 6 in the sit-sleeping support, the main part of the platform 6 is a board, there are two front and rear protrusions 8 and 10 on the edges of the platform 6, these protrusions are fixed on the platform 6 by screws 9 and 11, and the height of the protrusions can be very high; There are also two breathing holes 12 in the platform 6.

The bottom board 5 of the headrest 3 is flat, having an concavity 15 in the middle of the front side and an concavity 13 in the middle of the rear side. The concavity 15 and 13 are complementary to the protrusions 8 and 10, respectively; The bottom board 5 is fixed to the top platform 6 and so cannot move up and down left and right because they are complementary to each other when the concavity is placed around the protrusion. The headrest 3 includes concavities such as holes, pits and openings such as 13 and 15. The bottom plate 5 is further provided with a breathing hole 14. When the bottom board 5 is placed on the top platform, the breathing holes are well aligned, so that when the head is placed in the headrest, the exhaled gas can be discharged through the breathing holes of the two boards. The bottom board 5 is further provided with spacers to separate the bottom board 5 and the headrest base 4 for ventilation and for the head to breath. In fact, because the patient has to sleep in the prone posture for 8 hours in the bed at night, the headrest will become hot because the nose keeps exhaling hot air. If the heat dissipation is not good, the patient will feel uncomfortable, so the headrest generally has multiple breathing passages. The passage can be a groove, a hole or a gap between two boards. When the patient's head is placed in the headrest, the headrest can't block the nostrils of the patient's nose. The material inside the headrest should be at least 3 cm away from the nostrils. If there is something near the nostrils, there should be a breathing passages connected to exchange air and dissipate heat in other directions. The depth of the groove where the nose is to be should be at least as high as the nose, the better the higher.

From the above structure, we can conclude that the headrest is taken out from the sit-sleeping support and put on it without disassembling any parts at all; just align the concavity 13 of the bottom board 5 with the protrusion of the top platform 6 and drop the headrest then let it go; It's even easier to remove the headrest. Lift the headrest 3 and put the headrest on the bed or the bedside. The patient sleep in the prone posture by placing his head in the headrest. This kind of user experience is very good.

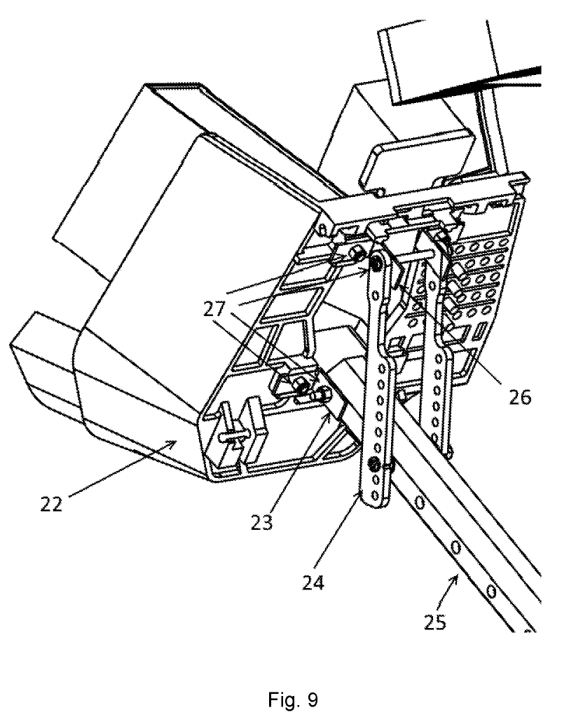

Let us look at the old headrest (FIG. 9). The headrest base 22 is fixed to the headrest supporting tube 25 by screws, nuts 27, angle irons 23 and 26. To move the headrest on the bed, first disassemble several screws and nuts, then assemble other parts such as the spacer 16 and the bottom board 5, these steps are too cumbersome; it is same cumbersome to switch from on the bed to on the sit-sleeping support, the spacer 16 and the bottom board 5 are removed, then the screws, nuts and angle irons are assembled to fix the headrest base 22 to the head supporting tube 25, this whole process is are too bothering.

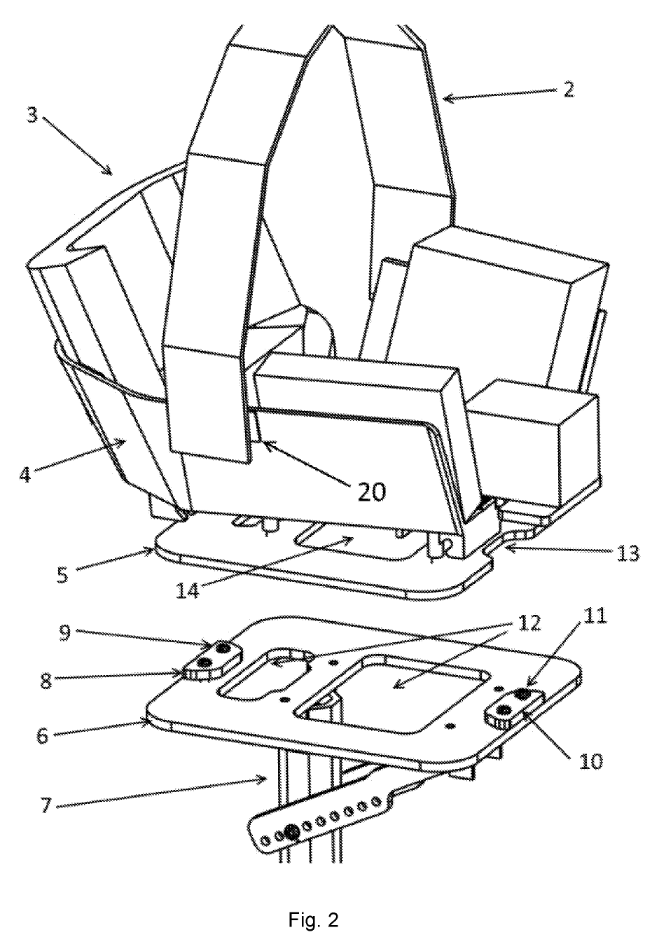

In addition, sometimes the patient will move his head out of the headrest and sleep face-upwards like a normal person when he is in a deep sleep, because the patient feel very uncomfortable in bed when sleep in the prone posture for a long time, then it is very likely that the surgically filled silicone oil will move randomly, resulting in postoperative recovery failure; In order to prevent the patient's head to be moved outside of the headrest, we use the headband 2 to tie the patient's head in the bases 4 and 18 of the headrest, and one end of the headband is fastened to the small base 18 by screw or rivet 19 (see FIG. 8), there is a loop and hook 20 on the other side of base 4 or headrest 3 (see FIG. 2), and there is a loop and hook on headband 2 too. The two loop and hooks are sticking together to tie the head 1 to the headrest 3 (see FIG. 1).

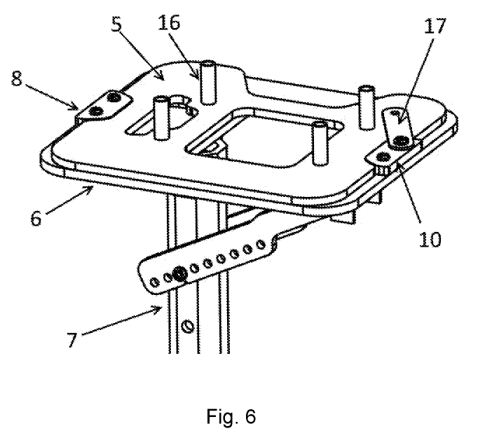

Referring to FIGS. 1, 5 and 6:

The difference between the embodiment 2 and embodiment 1 of the retinal detachment eye pillow and conversion method between different service states is that there is an extra thin lock-arm 17 in the embodiment 2, all the others are basically same. The lock-arm is attached to the rear protrusion 10 of the top platform 6, and the screw 11 fixes the lock-arm 17 to the protrusion 10. The lock-arm 17 can be elastic and can also be curved in shape. The lock-arm 17 is rotatable about the screw 11, and when not in use, the lock-arm is rotated out, then the headrest 3 can be taken out from the top platform 6 of the sit-sleeping support and placed on the bed or the bedside for the patient to use; if the patient want to use it, the concavity or opening 15 and 13 is aligned with the protrusion 8 and 10 of the top platform 6 then drop the headrest, then the lock-arm 17 is rotated in, and the headrest is locked on the top platform 6 of the sit-sleeping support.

Embodiment 2 is more stable than the embodiment 1 and the headrest 3 would not be turned over from the top platform 6 and fell due to misoperation.

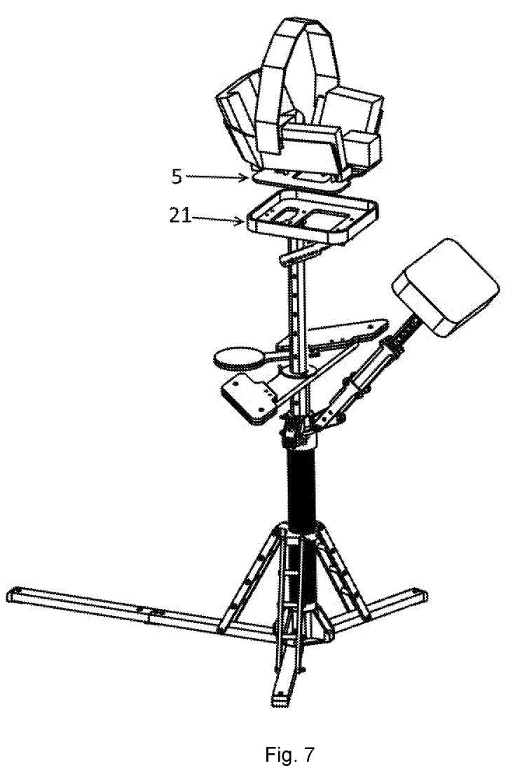

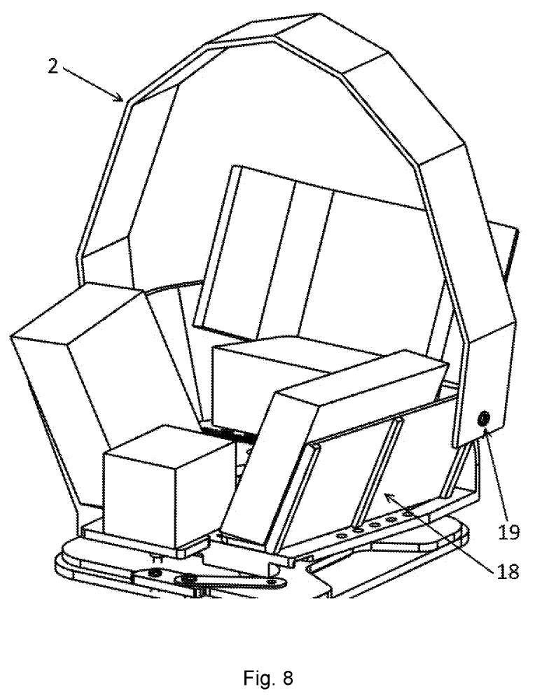

Referring to FIGS. 1 and 7:

The difference between the embodiment 3 and embodiment 1 of the retinal detachment eye pillow and conversion method between different service states is that there are upwards walls around the top platform 21 in the embodiment 3. The wall can be very high. The bottom board 5 can be placed on the top platform 21, the edges of the bottom board 5 are in close contact with the walls of the top platform 21, thus the headrest will not be turned over from the top platform 21 and fell because the close contact with walls will prevent the bottom board 5 from turning upwards.

Of course, the top platform can have no wall, but the bottom board 5 has a downwards wall. When it is used, the bottom board is placed around the top platform, and the edges of the top platform is in close contact with the walls of the bottom board, thus the headrest cannot be turned over from the top platform and fall.

There is still another embodiment corresponding to claim 2 not shown. Since embodiment 1 is better, this embodiment has only one protrusion, but close to the middle instead of on the edge of the top platform, and the shape of the only protrusion is not round, and there should be a corresponding concavity in the corresponding bottom board.

The above embodiments give the user very good user experiences without disassembling and assembling any parts. In addition, other headrests can be placed on the top platform of the sit-sleeping support, making the sit-sleeping support a platform.

1. A retinal detachment eye pillow and conversion method between different service states, wherein the said eye pillow comprises a headrest and a sit-sleeping support when sitting in a chair; there is a hole in the said headrest as a respiratory passage when the head is placed in the said headrest, the depth of the said hole is at least as high as the nose; the said headrest can be directly placed on the sit-sleeping support for use or be removed from the support for the patient to sleep in the prone posture on the bed; the conversion method from on the sit-sleeping support to sleeping in the prone posture on the bed is: moving the headrest upward, detaching it from the sit-sleeping support, placing it on the bed or a bedside tool, then the patient can sleep in the prone posture on the bed to use the headrest; the conversion method from sleeping in the prone posture on the bed to on the sit-sleeping support is: picking up the headrest from the bed or the bedside tool, align it with the sit-sleeping support, moving it down on the sit-sleeping support, then the patient can use the headrest on the sit-sleeping support.

2. The eye pillow and conversion method of claim 1, wherein the major part of the top platform of the said sit-sleeping support is a board and there is a protrusion on the said platform, the bottom board of the headrest is flat and there is a concavity in the said bottom board; the top platform contacts with the bottom board of the headrest and support the headrest via the contact; the concavity of the bottom board of the headrest is placed around the protrusion of the top platform to prevent the headrest from moving horizontally; when the patient want sleep while sitting, he can place the concavity of the bottom board of the headrest around the protrusion of the top platform of the sit-sleeping support, or detach the headrest from the sit-sleeping support by moving the headrest upwards if he want to uninstall.

3. The eye pillow and conversion method of claim 2, wherein there is another protrusion to help fix the headrest on the top platform of the said sit-sleeping support, and there is another concavity in the bottom board of the headrest, where the headrest is placed on the top platform of the support, the said concavity is placed around the protrusion of the top platform of the said support.

4. The eye pillow and conversion method of claim 1, wherein there are upwards walls around the top platform of the said support, the bottom board of headrest is flat and can be placed in the wall of the said top platform; or the top platform of the said support is flat, and there are walls around the bottom board of the headrest, the walls can be placed around the top platform of the said support; the top platform of the said support contacts with the bottom board of the headrest and support the headrest via the contact.

5. The eye pillow and conversion method of claim 1, wherein there is a rotatable lock-arm on the edge or protrusion of the top platform of the said support, the lock-arm is rotated in to lock the headrest onto the top platform of the said support when in use, or the lock-arm is rotated out when not in use.

6. The eye pillow and conversion method of claim 1, wherein more steps related to the lock-arm are required than those in the said method, the conversion method from on the sit-sleeping support to sleeping in the prone posture on the bed is: rotate the lock-arm out, moving the headrest upward, detaching it from the sit-sleeping support, placing it on the bed or a bedside tool, then the patient can sleep in the prone posture on the bed to use the headrest; the conversion method from sleeping in the prone posture on the bed to on the sit-sleeping support is: picking up the headrest from the bed or the bedside tool, align it with the sit-sleeping support, moving it down on the sit-sleeping support, and rotate the lock-arm in to lock the headrest then the patient can use the headrest on the sit-sleeping support.

7. The eye pillow and conversion method of claim 1, wherein there are holes for breathing both in the bottom board of the headrest and the top platform of the said support, the said holes are aligned when in use, thus the exhaled air can be discharged out of the headrest and the top platform of the said support.

8. A retinal detachment eye pillow and conversion method between different service state, wherein there is a band on the headrest, when the head of the patient is placed on the headrest, the band is placed around the head of the patient, the both ends of the band is attached on the both sides of the headrest.
